(19) United States
(12) Patent Application Publication
(10) Pub. No.: US 2021/0245911 A1
(43) Pub. Date: Aug. 12, 2021

(54) Vessel

(71) Applicant: Robert David Sager, Manhattan, KS (US)

(72) Inventor: Robert David Sager, Manhattan, KS (US)

(21) Appl. No.: 17/207,210

(22) Filed: Mar. 19, 2021

Related U.S. Application Data
(62) Division of application No. 15/983,830, filed on May 18, 2018.
Application No. 15/983,830 is a continuation-in-part of application No. 29/646,380, filed on May 3, 2018, now abandoned.
(60) Provisional application No. 62/583,944, filed on Nov. 9, 2017.
(60) Provisional application No. 62/612,255, filed on Dec. 29, 2017.

(51) Int. Cl. B65B 57/00; B65D 1/02; B65D 21/02; B65B 21/02; B65B 35/30; B65B 21/24; B65D 65/46; G06Q 10/00; B65D 71/70

(52) U.S. Cl. CPC B65B 57/00; B65D 1/0223; B65D 21/0223; B65B 21/02; B65B 35/30; B65D 2501/0081; B65D 21/0231; B65D 65/46; B65D 21/0202; G06Q 10/00; B65D 71/70; B65B 21/245

(57) ABSTRACT

The present application relates to a new vessel, such as a bottle that may be used to hold, store, or transport matter, such as particulates or fluids, and vessel assembly system. The vessel is constructed of a unique nesting design. Multiple vessels may be stacked together and to form a cohesive interrelated structure.

### CROSS-REFERENCE TO RELATED APPLICATIONS

This application claims priority to co-pending U.S. patent application Ser. No. 15/983,830 which is a continuation-in-part of U.S. Design Application No. 29/646,380, filed May 3, 2018, and which claims priority to U.S. Provisional Patent Application Ser. Nos. 62/583,944, filed Nov. 9, 2017, and 62/612,255, filed Dec. 29, 2017, the entire disclosures of which are incorporated herein by this reference for all purposes.

### FIELD OF THE INVENTION

Embodiments of the present invention relate generally to the form and function of a vessel (such as a water bottle or other similar container). More specifically, embodiments of the present invention relate to an improved vessel form, and methods related thereto, that provides significant functional advantages with respect to the manufacturing, storage, transportation, use and/or “disposal” (for purposes of the instant disclosure, the term “disposal” encompasses any activities of disposal, reclamation, recycling, reformulation, reuse, repurposing, or other post-initial-use disposition) of the vessel, and systems and methods of design, manufacturing, storage, transportation, use, disposal, form and/or function of a vessel. Other embodiments of the present invention relate generally to materials commonly used for product packaging and/or products that have relatively short life-cycles (e.g. disposable products, such as bottled water, etc.). More specifically, embodiments of the present invention relate to reversible/revisable/renewable/transformable and/or controlled/controllable-lifecycle, or controlled release materials, such as polymers, composites, compounds, metals, or other complex materials, and companion product cycles for such materials.

### BACKGROUND OF THE INVENTION

Historically, water bottles have been round in shape, with recent ‘square’ variants with the advent of plastic bottles. One notable ‘iconic’ exception to the ‘round’ rule, is the hour-glass shaped ‘Coke’ bottle, long in use by the Coco Cola company. At all times to date, the shape of a bottle for human consumables, such as water, has been either for convenience of manufacture, appearance, or for iconic recognition. For example, the ‘square with rounded edges’ form of the FIJI plastic water bottle carries with it a significant branding recognition. Notwithstanding, little if any consideration has been made, to date, for functional advantages in manufacturing, storage, transportation, use and/or disposal of the bottle design beyond brand recognition or the mere function of ‘holding’ a liquid. Certainly the iconic ‘Coke’ bottle eschews any visual or stated mission of storage or functionality beyond that of iconic trade dressing, trademark or patent of its ‘unique’ esthetics. Therefore, it would be desirable to provide a bottle or other vessel form that provides significant functional advantages with respect to the manufacturing, storage, transportation, use and/or disposal of the bottle.

With the advent of the ‘plastic’ portable water bottle, huge energy requirements have been brought to bear in regards to the making, storing and transporting of the product of convenience: bottled water. In the case of shipment, weight volume, and density carry a burden of economy. For example, with respect to traditional potato chips that have significant product irregularity within a single bag of product, they are as a product, extremely light and thus necessarily have a requisite excessive inherent ‘free space’ requirement of packaging. Though the weight and volume of both the product and packaging is negligible, in the case of potato chips, shelf space, storage space and transport space is inherently and excessively ‘voluminous.’ This can provide challenges, in particular in storage and transportation. The space that a typical bag of chips occupies is considerably high compared to weight, taking up more space on shelves for storage and in trucks during transportation. As a result trucks carrying a load of potato chips are so light that they are often easily blown off of windy highways. Alternatively, in the case of ‘Pringles’, the chips are processed into a consistent size and shape that stacks on top of one another, rather than varying sized sliced potatoes. The ‘volume’ of packaging is engineered to be minimized by varying the product itself to a standardized shape and interrelationship of individual elements. As a result, Pringle® chips can be more densely packed for storage and transportation, reducing the risk of trucks blowing off the road, as well as decreasing overall storage and transportation costs. The Pringle® example, re-engineers only the made-product to fit a conventional standardized cylindrical packaging, storage and transportation form and strategy, but does NOT re-engineer the vessel of containment itself. While semi-trailer trucks of Pringles may be less likely to blow off the highways of windy Western Kansas because of the increased weight and density per unit volume of ‘potato chip’ formatting, the space between the Pringles cans in bulk packaging is still a waste of space requiring cartage. Therefore, it would be desirable to provide a vessel form that provides significant functional advantages with respect to the manufacturing, storage, transportation, use and/or disposal of the vessel, and systems and methods of design, manufacturing, storage, transportation, use, disposal, form and/or function of a vessel.

In recent times, global consciousness has focused on wellness, and socially/environmentally-friendly products and packaging. Increased consumerism and consumer mobility have created large amounts of packaging waste. Recent shifts from local consumer shopping to home delivery has necessarily destined increased packaging waste. To date increased social activism has focused on employing ‘renewable resources’ and ‘re-cycling’ primarily by repurposing the materials of packaging to try to manage the waste of contemporary living. Such methods embody inherent increased hauling, sorting, reclamation, etc., consequences.

To deal with the conundrum of politics and business in sensitive times, product/packaging companies have adopted inspiring Nature-centric and/or Human-sensitive trade dressing initiatives to imbed contemporary caring/philanthropic corporate images and prowess in marketing and consumer education. To date, Nature-centric interests of product/packaging have focused on renewable resources (near-term agriculture biomass sources) rather than traditional resources (long-term ancient fossil biomass sources). By way of example, companies, such as Coca Cola's Dansani Water have recently embraced both Nature-centric and Human-sensitive trade dressing by adopting a plastic bottle made from 30% renewable ‘plant’ sourced (Nature-centric) raw material to carry ‘processed’ water. Other companies use ‘Human-centric’ or ‘Human-sensitive’ trade dressing to market the fact that they donate a portion of the proceeds from sales of their products to environmental causes. While the marketing promotes an industry cycle-logo centered on a plant leaf, the product does not ‘re-imagine’ the plastic bottle into a transformative product & packaging, but rather ‘manages’ the plastic bottle by giving it desirable trade dressing and contemporary ‘caring/philanthropic’ corporate imaging. Packaging such as the Dasani water bottle does not in any way materially transform or elementally maintain the product within, or favorably affect the energy requirements of waste management of post-consumer consumption. While the Dasani marketing promotes corporate responsibility, the reality is their Dasani packaging recycling requirements perpetuate the same unbridled energy requirements of hauling, sorting, recycling/repurposing of the prior art. Highways, byways and shorelines worldwide are littered with all manner of un-recycled/un-repurposed plastic waste, including Dansani water bottles complete with the Nature-sensitive logos.

In former times before the great ‘Soda Wars’ of recent times, soft-drink glass bottle packaging carried with it/them State-specific tariffs imprinted on the side that encouraged consumer or scavenger collection/re-use of the containers by the originating company. In more recent times, aluminum packaging, whose material resource required international importation, carried similar recycling tariffs that incentivized recycling for consumer cash. In recent times, more affordable plastic packaging has escaped a pre-planned recycling plan, and has eschewed product-packaging innovation, effectively housing the product for a specified shelf life inherent to the packaged items. In this case, all manner of environmental responsibility has been sidestepped in the race for sales and product turns.

While great strides have been made in packaging quality and consistency to do the specific container job, e.g., safe preservation, etc., packaging, Compangineering, for ‘inherently imputing’ for the betterment/enhancement of the product short or long term, or reducing energy needs of recycling/repurposing, has been largely ignored in the prior art in the race for ever-changing product and packaging prowess.

Therefore, it is desirable to provide reversible, controllable and/or controlled release materials, such as polymers, composites, compounds, metals, or other complex materials, and companion product cycles for such materials, wherein the life cycle of the product/packaging is contemplated and cooperatively planned as part of the original design process (“Compangineering”).

### SUMMARY OF THE INVENTION

Embodiments of the instant invention provide a vessel form that provides significant functional advantages with respect to the manufacturing, storage, transportation, use and/or disposal of the vessel, and systems and methods of design, manufacturing, storage, transportation, use, disposal, form and/or function of a vessel. In some embodiments, the vessel is in the form of a bottle for a liquid, such as water or other beverages. In some embodiments, the vessel is formed to have a purposeful geometric form. In some such embodiments, the geometric form is generally a triangular cross-sectional shape. In other embodiments, other cross-sectional shapes (e.g. rectilinear, round or square) now known or hereafter developed are utilized in a purposeful manner to functional advantages with respect to the manufacturing, storage, transportation, use and/or disposal of the vessel. In some embodiments, the vessel includes internal and/or external integral structural nuances that may provide aesthetic benefits but that also have functional benefits/purposes (e.g. to enhance strength or support the shape of the vessel). In some such embodiments, internal features include corrugation, thickened areas of material at corners or other strategic locations, fins, etc. In some such embodiments, the exterior surface of the vessel is generally smooth to increase efficiencies of storage/transportation, etc. In some embodiments, the contents of the vessel aid in maintaining the shape, structure, or other functionality of the vessel. In some such embodiments, the vessel is designed purposefully to utilize the contents to help maintain the shape, structure, or other functionality of the vessel. In some embodiments, the shape of the vessel changes when the contents are removed. In some embodiments, when the contents of the vessel are removed, such action acts as a trigger to initiate a transformation of the composition of the vessel. In some embodiments the vessel is designed purposefully to contract in size (e.g. for increased efficiency/reduction of energy in recycling) upon removal of the product/contents from the vessel. In some such embodiments, the contraction of the materials of the vessel result in a shape/form that requires less energy for further recycling, reclamation, or other repurposing/use of the vessel. In some embodiments, the vessel is in a contracted state following manufacture of the vessel, aiding in more efficient storage and transport until the vessel is filled with product. In such embodiments, upon filing of the vessel with product (e.g. water), the vessel expands in shape. In some such embodiments, the vessel contracts to its original shape when the product is removed. In other embodiments, removal of the product results in contraction to a different shape from the original shape and different from the filled shape. In some embodiments the vessel is designed using a ‘Compangineering’ process as further described in U.S. Provisional Patent Application Ser. No. 62/583,944, filed Nov. 9, 2017, the entire disclosure of which is incorporated herein by reference. In some such embodiments, the vessel is designed as part of the life-cycle with shipping, disposal and/or storage functionality being contemplated as part of the initial design.

In some embodiments, the vessel of the inventive concept is made from a blow molding process. In other embodiments, other manufacturing methodologies are utilized. For example, with respect to the triangular and/or rectilinear cross section embodiments of the inventive concept, some embodiments are manufactured from flat sheets or films of material that are formed to the triangular and/or rectangular shape and welded along the seam. In some such embodiments, the bottom and/or top of the vessel is made in a manner similar to that of paper milk cartons.

Applying the process of WellWater ‘Compangineering’, both the product and packaging benefits from all matters of product, packaging, storage and transport being considered simultaneously. In the case of the Well Water® vessels, all manner of the final form and function is scrutinized simultaneously with the product and its purveyance/conveyance. In some embodiments, the final form and function is also scrutinized simultaneously with the method of disposal for the vessel. The ‘bottle’ for WellWater is a strategy that has implications far beyond the storage of water, but instead is an entirely new study of economy of energy and entropy of storage and conveyance applicable to many consumables. In the case of WellWater ‘bottle’, the ergonomics of human manipulation and use is considered as a starting point in the design for Compangineering. That is not to say that such Compangineering requires any staring point of imagination of creation, but rather it is to say that possibly it is a reasonable point of view for ingenuity and new art. In other words, in some embodiments, the method of design of the vessels of the inventive concept includes steps of evaluating various one or more stages during the life cycle of the vessel. For example, the triangular and rectilinear cross section bottles of embodiments of the inventive concept take into account during the design process the function benefits of the design for storage, transportation, and use (grip-ability).

In the case of a water bottle, it is understood via prior art that a bottle could be a large bottle intended for multiple servings use and/or multiple individual servings for individual use. Large water vessels of prior art may be of ‘other forms’, such as large boxes with grip-able squared corners and/or large rounded vessel with grip-able handles either an integrated part of the packaging and/or an added appendage. Indeed, from antiquity, terracotta vessels with handles have been commonly used for the transport and/or storage of water and oils for millennia. Moreover, individual rounded and squared water bottles for individual use are also known in conventional prior art. In the case of some embodiments of the instant inventive concept, a WellWater water bottle intended for individual and singular use, the visible external ergonomics of form and function will play an important role in not only use of the encapsulated product, but also recognition of the product itself (e.g. the unique shape is distinctive), ad modem the iconic Coke bottle. Nevertheless, beyond simple recognition such as the Coke bottle in a ‘branding’ mission for the contents within the bottle, recognizable form and function will also be Compangineered to embody a ‘coincident intersection’ with/of more esoteric and/or important functional aspects of the vessels' interrelation with other such vessels. For example, in some embodiments the functional aspects include ‘value added’ benefits in the storage and transportation (the triangular or rectangular shapes stack together filling all space), and/or ‘amplified utility’ in regards to manipulation by human or robotic ‘hands’ (the triangular and/or rectilinear shape is easier to grip). Although shown and described in connection with a water bottle, it will be appreciated that various embodiments of the instant invention will be utilized in connection with vessels for other items, including other drinkable liquids, non-potable liquids, solids, or other items.

At all times the WellWater strategy is a strategy of and for wellness, for the consumers of contained products and their packaging/containers/vessels, Compangineered lifecycles of packaging/containers/vessels, and conservation of energy and entropy for all living individuals and groups. Such packaging/containers/vessels, in some embodiments will also contain water from wells and/or other natural and enhanced sources. Such packaging/containers/vessels will in some embodiments be made from materials now known or hereinafter discovered. In some embodiments, vessels of the invention are made from known plastics and in a manner similar to that of disposable plastic water bottles (e.g. from polyethylene terephthalate, P.E.T., plastics). In some embodiments, vessels of the invention are made from Compangineered materials of the type described in U.S. Provisional Patent Application Ser. No. 62/583,944, filed Nov. 9, 2017, the entire disclosure of which is incorporated herein by reference. In some embodiments the packaging/containers/vessels will be either of simple containment and/or of some periodic, controlled and/or continuous participatory purpose, consistent with a conservation of energy and entropy, and the subject to additional Compangineered activity(s) as part of the design process.

It will be appreciated that the systems and methods of various embodiments of the inventive concept apply to vessels for various forms of products beyond water/liquids. Some embodiments of the inventive concept method broadly apply to any purposeful design of a vessel to optimize the placement of multiple vessels within a containment area (e.g. storage/display shelf, shipping container, etc.) to achieve maximum density within the area. Such embodiments of the instant invention, referred to as the inventors' FormChain Technology, provide for increased flexibility for physical packaging storage and transportation in a manner similar to the flexibility achieved in the digital storage and transmission through BlockChain technology.

In some embodiments, the systems and methods disclosed herein are utilized in connection with a product itself, which is broadly defined as a “vessel” of the inventive concept. For example, in some embodiments, the external shape of a vacuum cleaner, or other product, is designed using the systems and methods of the inventive concept to increase efficiency of storage/transportation of multiple units of the product together. For example, in some embodiments, a vacuum cleaner is designed to have a generally triangular cross sectional shape, such that multiple vacuum cleaners can be stacked together more densely within a shipping container.

Embodiments of the apparatuses, systems and methods of the inventive concept create a mechanism/metric for multiple quantities of the product packaging/vessel for the cartage/storage of the product and/or product within the packaging. Prior to the advent of the instant inventive concept products such as aircraft fuselages (such as the iconic Boing 707/737) were designed to fit within certain transportation parameters. In the case of aircraft, the fuselages were designed to fit through railroad tunnels when placed on the train cars. The size of the tunnels was thus a limiting factor on the size of the fuselages. Conventional shipping crates are sized to fit within international shipping containers. Nevertheless, no thought is given to maximize efficiency of storage/transport within the containers. The instant invention allows for a mechanism to take maximum advantage of the space provided within a shipping container or other storage/transport space. In some embodiments, the container of the instant invention is optimized in conjunction with the sizing of the product within the container to result in the most efficient use of energy as it relates to the mass of the products within the container and time. In some such embodiments, the mass of the container itself is also taken into account as part of the determination of efficiency. In some such embodiments, the term “product” used above encompasses smaller containers for other products that are sized to fit within one or more larger container(s) (e.g. in one exemplary embodiment, a first container or products is a water bottle, a second container or product is a case of multiple bottles of water, and still a third container is a shipping container housing multiple cases of water—in yet another embodiment, a fourth container is a ship housing multiple shipping containers).

Some embodiments of the instant invention provide materials and companion product cycles that are designed to reverse the trend of prior art product packaging by Compangineering the product, packaging and recycling at the outset. For purposes of the instant invention, all product resources are considered finite and all manufacturing and use possibilities are considered infinite. At the heart of the instant Compangineering invention is the significance of water as both an energy and resource for the product and product cycle. One embodiment of the inventive concept provides the capability for the packaging to impart to and/or obtain from the contents of the packaging a sustaining and/or transformative capability. Another embodiment provides for the packaging to be reversible, revisable, and/or renewable solely by means other than prior art of high energy (whether in manner and form of temperature or mechanistic manipulation, e.g. crushing, grinding, shredding, etc.). Another embodiment provides for the packaging to have an intended Compangineering command method of un-zipping, dissolution, reversibility inherent to the specific elemental and/or compound nature of the product and/or its packaging. Another embodiment provides for the reclamation of the packaging for reuse or repurposing in a manner that is inherently shifted to an earlier point in the consumer disposal-reclamation cycle so as to conserve energy. Another embodiment fosters Compangineering to employ all applicable holistic and scientific methods to support product and packaging integrity/health throughout the life cycle of the product and packaging to its return to Nature and or the production line. Embodiments of the instant invention provide for Compangineering for the whole cycle, from original design of the product and/or packaging, through sale and use/consumption by the consumer, all the way to disposal/reclamation/recycling/etc. In some embodiments, the cost of the product containing takes into account the cost of disposal/reclamation/recycling/etc. In such embodiments, the consumer may pay more for the product (e.g. a bottle of water might cost $0.05 more than one of the prior art) at the point of purchase, but in the end saves money, time and/or other resources by having a planned and effective means of disposal/reclamation/recycling/etc.

Some embodiments of the instant invention include materials, such as Compangineered known polymers used for packaging in the food, water-beverages, pharmaceutical, etc. fluid industries. In other embodiment the materials of the instant invention include new compositions of and/or new uses of existing polymers, composites, compounds, metals, or other complex materials that offer more than one feature/capability/capacity/intentional design (e.g. materials that function as packaging but also include reversible and/or controlled release properties). In one embodiment, inventive Compangineered materials bolster the product during its purposed use for containment via a preferred compounding of all or some of the elements/compounds/features of the product and/or its packaging. This is a one-way product methodology, notwithstanding the recycling aspects of the principals involved. The resultant capabilities of the requisite methods and materials of the instant invention are intended to render the packaging an inherently revisable, renewable, and/or reversible item.

The instant invention provides an ‘ashes to ashes’ concept within a product lifecycle. Humans have a finite life, and then we return to the soil from which we came. But as Humans to date, we have endeavored to make materials to be durable and indestructible without an eye to their cycle of returning to the soul. For purposes of discussion of the instant inventive concept, fossil fuels are referred to as “recycled biomass”. Although it takes billions of years, fossil fuels are nevertheless ultimately ‘recycled’. In that context, coal and oil are renewable resources. Deep dumping waste in an oceanic trench would likely do a better job of recycling than landfills, as the depth would transform materials more successfully and quicker. The trouble with prior art plastic containers, however, is that they often float, and their carbon/composite structures take longer than a human lifecycle to re-cycle. Moreover, using farmland to grow corn/agricultural crops (prior art—renewable resources) for container materials plunders our potable water aquifers servicing pivot irrigations and our roads hauling re-allocated food and replenishing fertilizers at a high energy cost, in lieu of employing fossil fuels. The instant invention overcomes such deficiencies in favor of ordered entropy envisioned by the inventive Compangineering processes.

The materials of the instant invention comprise a new class of compounds/polymers/plastic/materials, referred to as POLYREPLETES, designed to do more than just be a static final form of a making of one of the class products arising from a Compangineering process that has an inherent/pre-planned reversible/revisable/renewable and/or transformational property/capability. In other words, Polyrepletes are a new-age new-class of ‘plastics’ (‘plastic’ being referenced herein as being something of a slang/common consumer term for an entire class of materials, and not intended to connote or denote any actual material) that serve to be Compangineered to degrade or transform in ways that do not require excess TIME or ENERGY of prior art materials to revert to their original components, and/or on command transform to their original components, and/or convert to a base for another pre-determined Polyreplete, and/or convert/transform to components or new/differing materials which are easily disposed of by the end consumer. For example, in some embodiments a plastic bottle for hygienically packaging potable water, by the process of the instant invention is capable of being recycled without excess (commonly currently expected) TIME or ENERGY to decompose, reduce in volume or form for repurposing (i.e., grinding for use as fiber or melting for reformation). Embodiments of the materials of the instant invention are designed to decompose/transform/sublimate without the addition of energy, e.g. at a temperature below the boiling point of water or the ‘melting’ point of the substance of the Polyreplete itself, and/or or conventional metrics of prior art.

It will be appreciated that embodiments of the POLYREPLETE(S) material(s) of the instant invention include metal ions/compounds/amalgams, etc., and/or any other element(s) or material(s) that is/are designated to be/be part of more than just a one-way vessel of containment (can/bottle/drum, etc.), and/or are designed to be a total-solution vessel compangineered POLYREPLETE that has reversal/repurposing/recycling pre-planned.

In some embodiments, the materials of the instant invention comprise polymers, or other complex materials, that are designed to reverse polymerize (for purposes of the instant invention, the phrase “reverse polymerize” applies to any materials, or components thereof, of the instant invention, whether polymer or other form) upon the occurrence of a predetermined triggering event. In some such embodiments, the predetermined event is the application of a triggering agent (such as a chemical, voltaic, nuclear, etc.) that activates the reverse polymerization/transformative process. In other embodiments, the triggering event is a temperature. In some such embodiments, the temperature is a temperature that is below a typical melting point of the component materials and/or temperature composite of prior art, but raising the temperature to a specific threshold that is capable of functioning to start the reverse/de-polymerization process. In other embodiments, lowering the temperature below a threshold initiates the process. In some embodiments the trigger is a moisture level. In some embodiments the trigger is a pH or acid level. In some embodiments the trigger is an enzyme or element(s) acting as an agent of change (catalyst, cofactor, etc.) that is applied to the Compangineered material. In some embodiments the trigger is a shear, pressure, force, stress on the material that initiates the reversal/repurposing polymerization process. In some embodiments, the trigger is based upon a predetermined time interval to initiate, effect, and/or complete to reversal/repurposing process.

In some embodiments of the instant invention, the material is comprised of or includes one or more layers of material that include controlled release properties, elements, compounds, etc. For example, in some embodiments, a water bottle of the inventive concept includes an inherently identifiable characteristic, layer, element, or compound, facilitating controlled release agent of capability, integrally and/or along the inner surface of the bottle, that releases fluoride and/or flavoring into the water within the container. In some embodiments, the material of the bottle itself (e.g. the entire bottle, not just a layer on the inner surface) is a controlled release material, compound, element, agent, etc., to release the fluoride and/or flavoring. At all times, the Compangineering concept anticipates the concomitant full product/packaging cycle. In some embodiments, the controlled release materials of the instant invention comprise polymers, or other complex materials, that are designed to release the payload within the material upon the occurrence of a predetermined triggering event. In some such embodiments, the predetermined event is the application of a triggering agent (such as a physical, chemical, voltaic, nuclear, etc.) that activates the release process. In other embodiments, the triggering event is a temperature. In some such embodiments, the temperature is a temperature that is below a typical melting point of the component materials, but raising the temperature to a specific threshold is capable of functioning to start the release process. In other embodiments, lowering the temperature below a threshold initiates the process. In some embodiments the trigger is a moisture level, while in some embodiments the trigger is a pH or acid level, be it inherently initiated or externally induced. In some embodiments the trigger is an enzyme or element that is applied to or imputed into a material of the instant invention. In some embodiments the trigger is a pressure, shear and/or tensile stress on the material that initiates the reverse/repurposing polymerization process. In some embodiments, the trigger is based upon a predetermined time. In some embodiments, the inventive concept includes both a reverse polymerization and also includes controlled release properties.

Some embodiments of the instant invention include method(s) of using materials that are capable of reverse/repurposing polymerization and/or controlled release of a ‘payload(s)’ that is/are designed into the life cycle of the product/packaging and planned as part of the original design process (“Compangineering”). In some such embodiments existing known material technologies that are capable of reverse polymerization and/or controlled release of payload, are utilized in connection with the Compangineering process of the instant invention. In the inventive process, the materials are selected based upon the desired triggering event for decomposition and/or repurposing release. The container/product itself is designed from the origination with the purpose of end use and decomposition in mind, and the particular material utilized is selected with such purpose.

Some embodiments of the instant inventive concept include a bottle for water or other liquids. In some such embodiments, the material is colored (other than clear of traditional water bottles; e.g. green). In some embodiments, the bottle includes a cap that is designed as part of the bottle life cycle. In some such embodiments, an improved tamper-resistant cap is utilized. In some embodiments, the bottle includes a triangular cross section that allows for increased strength and space-saving/shipping/shelving benefits. In some such embodiments, the shape of the bottle is designed as part of the life-cycle with shipping and/or storage functionality being contemplated as part of the initial design.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description, wherein is set forth by way of illustration and example, an embodiment of this invention and various features thereof.

### BRIEF DESCRIPTION OF THE DRAWINGS

A preferred embodiment of the invention, illustrative of the best mode in which the applicant has contemplated applying the principles, is set forth in the following description and is shown in the drawings and is particularly and distinctly pointed out and set forth in the appended claims.

FIGS. 1, 2 and 3 are top views of a water bottle of an embodiment of the inventive concept (FIG. 1) shown in comparison analysis to square (FIG. 2) and rounded (FIG. 3) water bottles of the prior art.

FIGS. 4A through 4E show a space comparison analysis between various embodiments of water bottles (1) of the inventive concept, including square cross section (4A), rectangular cross section (4B), triangular cross section (4C) and rounded cross section (4D), for all bottles including neck forms and twist caps similar to those of the prior art.

FIGS. 5A through 5E show a space comparison analysis between various embodiments of water bottles (2) of the inventive concept, including square cross section (5A), rectangular cross section (5B), triangular cross section (5C) and rounded cross section (5D), for all bottles including neck forms of an embodiment of the inventive concept including a twist cap closure.

FIGS. 6A and 6B show a space comparison analysis for a triangular bottle (3) of the inventive concept including a flip portal closure and/or companion element.

FIGS. 7A through 7E show a space comparison analysis between various embodiments of water bottles (4) of the inventive concept, including square cross section (7A), triangular cross section (7B), and circular cross section (7C), for bottles including an accordion neck (Q) of the inventive concept.

FIGS. 8 through 11 show an adjacency comparison analysis between various embodiments of water bottles (4) of the inventive concept, including square cross section (FIG. 10), triangular cross section (FIG. 8), circular cross section (FIG. 9) and rectangular cross section (FIG. 11).

FIGS. 12 and 13 show an adjacency packaging comparison analysis in perspective view between various vessel embodiments of the prior art, including a typical disposable water bottle (FIG. 12), and a typical soda can (FIG. 13).

FIGS. 14A through 16 show a preferred human interface comparison analysis between various vessel embodiments of the inventive concept, including triangular cross section (FIGS. 14A and 14B), rectangular/rectilinear cross section (FIGS. 15A and 15B), square cross section (FIG. 17), and circular cross section (FIG. 16).

FIG. 18 is a front elevation view of a water bottle vessel embodiment of the instant inventive concept, including structural features for horizontal and vertical interlock with other bottles of identical structure.

FIG. 19 is a rear elevation view of the water bottle of FIG. 18.

FIG. 20 is a left side elevation view of the water bottle of FIG. 18, looking toward a female horizontal interlock structure.

FIG. 21 is a right side elevation view of the water bottle of FIG. 18, looking toward a male horizontal interlock structure that mates with the corresponding female interlock structure of other identical bottles.

FIG. 22 is a bottom plan view of the water bottle of FIG. 18, looking toward a female vertical interlock structure.

FIG. 23 is a top plan view of the water bottle of FIG. 18, looking toward a male vertical interlock structure that mates with the corresponding female interlock structure of other identical bottles.

FIG. 24 is a frontal perspective view of a grouping of vessels of FIG. 18 being stacked together horizontally and vertically.

FIG. 25 is an exploded frontal perspective view of a grouping of vessels of FIG. 18 stacked together and positioned upon a pallet of the inventive concept

### DETAILED DESCRIPTION

As required, a detailed embodiment of the present invention is disclosed herein; however, it is to be understood that the disclosed embodiment is merely exemplary of the principles of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

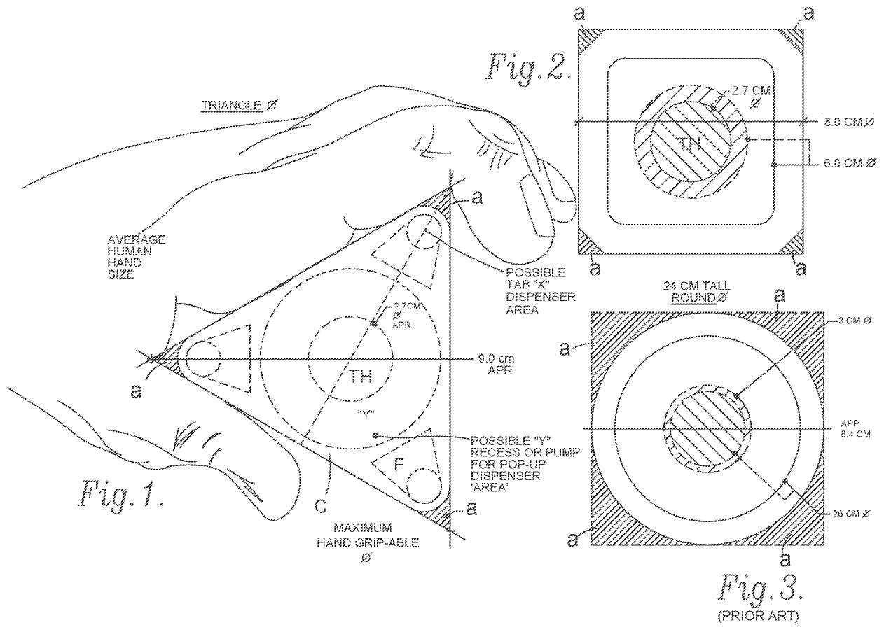

Referring to FIGS. 1 through 3, a triangular cross-section water bottle (C) of an embodiment of the inventive concept is shown in comparison analysis to round (D) and square (A) cross section water bottles of the prior art. FIG. 1 shows how an average human hand comfortably grips the triangular cross section design. FIG. 1 also shows areas of “wasted space” (a) at the rounded/chamfered corners of each of the cross sectional bottle shapes, and demonstrates how the instant inventive concept works to minimize wasted space about the exterior during storage, transport, etc. of the vessel while maintaining interior capacity. It will be appreciated that in some embodiments of the inventive concept, rounded/chamfered corners are utilized for aesthetic and/or functional purposes, despite the fact that such corners result in a small amount of wasted space. The square bottle shown in FIG. 2 is representative of the cross sectional shape of a Fiji brand water bottle of the prior art. The circular/rounded bottle shown in FIG. 3 is representative of the cross sectional shape of a Dasani and/or Life Water brand water bottle of the prior art. As is shown in FIG. 3, the circular cross section shape results in significant wasted space adjacent to the outer surface of the vessel.

FIG. 1 illustrates several embodiments of conveyance portal openings, transitions and closures of the inventive concept on the top of bottle C, through which a user of the bottle may drink the liquid/contents from the bottle. It will be appreciated that the conveyance portal openings, transitions and closures shown in FIG. 1 will be utilized in some embodiments individually, and in other embodiments in combination with one or more of the openings, transitions and/or closures shown. It will further be appreciated that other conveyance portal openings, transitions and closures, now known or hereinafter developed, will be utilized in other embodiments without departing from the spirit and scope of the instant inventive concept.

FIG. 1 shows a flip up portal cover (F) located over portal openings of each of the corners of the triangular top of the bottle C. In some embodiments, the flip up cover is connected to the top of the bottle via a living hinge and reclosable/resealable by the user. In some such embodiments, the flip up cover includes an internal groove that mates with a lip on the top of the bottle to seal the closure. In some embodiments, the flip up cover is similar to pop-top soda can opening mechanisms of the prior art, in which the tab is removable from the top and discard. In other embodiments, the flip-up cover is similar to stay-tab opening mechanisms of soda cans of the prior art, in which the tab stays connected to the top. In other embodiments, the flip up cover is a peel-away tape or other material that covers the portal opening. In some such embodiments, the tape is resealable.

FIG. 1 shows a twist off cap portal cover (TH). In some embodiments, the cap is similar to those of water bottles of the prior art. In some embodiments the cap covers a portal opening located in a rigid neck transition area in which the neck (AC) tapers or otherwise reduces in diameter/width from the body portion (AD) of the bottle to a cap-neck transition area (AB) from which a threaded cap retention area (AA) extends. The cap TH includes internal threads, or other suitable retention mechanisms now known or hereafter developed, for holding the cap TH to the threaded cap retention area AA In some embodiments, the cap covers a portal opening located in a compressible or dynamic neck transition area (Y), as is shown in FIG. 1. In some such embodiments the transition area (see Q in FIG. 7) is a pop-up accordion shape that is capable of compressing dynamically down into a recess or onto itself to reduce the height of the neck transition area during storage, transport or other period of non-use of the bottle. In some embodiments area Yin FIG. 1 includes a recess for housing the pop-up neck of the bottle when it is compressed to a non-use position. In other embodiments, area Y includes a pump or other structural feature to assist in moving the pop-up neck of the bottle from a compressed/non-use position to an extended position.

The triangular and/or rectilinear cross section of some embodiments of the vessel allows for increased strength and space-saving/shipping/shelving benefits. FIGS. 1 through 3 shows a comparison of functional benefits of ergonomics and storage of a bottle of triangular cross section of the instant inventive concept vs. conventional round and/or square bottles. In some embodiments, the triangular cross section is that of a equilateral triangle. It will be appreciated that in other embodiments, alternative triangular forms will be utilized (e.g. isosceles, scalene, acute, obtuse, right), depending upon the functional properties desired. FIG. 1 shows vessels of the instant inventive concept having equilateral triangular shape. Other embodiments of the inventive concept include right triangle shapes. The use of right triangular shaped vessels allows multiple vessels to be stacked together to form a square. It will be appreciated that in some embodiments, multiple right angled vessels are stacked together to fill a square or rectangular storage/transportation space (e.g. a shipping container). In some embodiments that use of an equilateral triangle shape, when multiple vessels are stacked together of the same shape, the end of the stack includes a triangular gap. In some embodiments in which equilateral triangle vessels are utilized, the storage/transportation area is shaped such that an end includes a triangular shape that mates with the shape of the end of the stack, allowing for maximum utilization of space within the area. In some embodiments of the inventive concept, multiple different shaped vessels are stacked together to utilize maximum space within a storage/transport area.

Referring to FIG. 1, a ‘standard-to-smaller’ human hand size (8-9 glove size) is shown to illustrate the ergonomics of human ‘grip’ of shapes. The ‘standard-to-smaller’ size is utilized in some embodiments so as to not instantly disadvantage the ‘easy-grip’ capabilities of the instant invention by the average human. It is appreciated that the volume of any given vessel is a function of not only its cross sectional base/shape but its overall height. In some embodiments of the inventive concept, a maximum and/or minimum height is taken into consideration as a Compangineered requisite parameter for the overall design. In analyzing the capability of the human grip in the context of the inventive concept, it is appreciated that in some embodiment's of the inventive concept there is a ‘sweet spot’ of capability for each size, relative to the sizes of standard forms of round and/or square bottles that are typical of prior art plastic water bottles.

Based upon initial examination of the inventive concept, it is understood that the human hand is able to grip a slightly bigger cross section of a triangle than square because the human hand is able to grip an angle less than 90 degrees easier than that of a round or square surface devoid of external irregularities, such as the Iconic Coke bottle. In some embodiments, based upon the average size of a human hand, and volume of contents desired within a vessel, an ‘ideal’ formula of height to cross section is obtained. A triangular form is observed to ‘fit’ the junction of the ‘opposable thumb’ and ‘first digit’ that most readily assumes a triangular nexus. Realizing that volumes of varying forms with the manifestations of their resulting mathematical geometric cross sectional formularies, the intention some embodiments of the WellWater Compangineering of the instant invention is to glean a favorable cross sectional-to-volume strategy. As such, it is conducive that some embodiments of the instant invention of the WellWater bottle is Compangineered concomitant with advantages over prior art in the area of conserving both energy and entropy with regards to consumable products, such as polymer vessels for potable water. Nevertheless, it will be appreciated that various embodiments of the inventive concept will be utilized for containment of other liquids, solids, or other substances now known or hereinafter discovered.

It is noted that the filler/use portal (e.g. the opening at the top of the bottle), and transition area (e.g. the bottle neck) to the filler/use portal (which traditionally combine to function as transition from the bulk container portion of the vessel to the end use, such as a user's mouth) with overall form of the instant invention, in some embodiments will itself be the subject of other invention and not contingent to/of the form or function of those of the prior art shown herein. Indeed, in some embodiments the filler/use portal and transition at all times will be the subject of a Compangineered strategy for the instant invention. As such, a vessel of some embodiments of the instant invention is complete with the filler/use portal and transition area to the filler/use portal will be an additional strategy in conserving energy and entropy of the entire lifecycle of WellWater containment vessels and product beyond that of similar vessels of prior art. In some embodiments, the filler/use portal is a tab or removal seal/label positioned along a generally flat surface of the vessel (similar to that of a soda can). FIG. 1 shows various options for dispenser areas “X” located adjacent to one or more corners of the triangular cross section, or “Y” at a center of the triangular cross section. The flat top of such embodiments provides additional functional benefits for storage and/or transportation, allowing multiple vessels to be stacked on top of one another. In other embodiments, the filler/use portal and transition area are designed to be intertwined within the internal volume of the vessel and/or made to be dynamic for externalization, providing a flat top when closed, and a protruding filler/use portal when open. Some such embodiments include accordion style and/or Nuk style nipple that is recessed. within the vessel in a closed orientation, and that is pulled out to protrude from the top of the vessel in an open orientation.

FIG. 1 also shows several areas, a, that indicated the amount of wasted space due to rounded corners or the round shape of a round bottle. In some embodiments of the invention, the vessel includes rounded corners, such as shown in FIG. 1. The rounded corners allow for improved grip by a user. Other embodiments utilize non-rounded corners to maximize usage of internal space.

It will be appreciated that any dimensions shown in FIGS. 1 through 3 are for exemplary purposes only, and not intended in any way to limit the various sizes and shapes of embodiments of the inventive concept.

FIGS. 4A through 4E show a space comparison analysis between various embodiments of water bottles (1) of the inventive concept, including bottle A with a generally square cross section (FIG. 4A), bottle B with a generally rectangular cross section (FIG. 4B), bottle C with a generally triangular cross section (FIG. 4C), and bottle D with a generally rounded/circular cross section (FIG. 4D). All bottles shown in FIG. 4 include rigid neck forms and twist caps similar to those of the prior art, in which neck AC includes a relatively long tapered transition from body AD to the cap-neck transition AB. As is shown in FIG. 4, the square and rectilinear cross sections result in the least amount of wasted space (a) in the locations adjacent to the main body portion AD of the bottle. This allows multiple bottles of similar shapes to be positioned adjacent to each other for storage, transport, etc. As is shown in FIG. 4C, the triangular cross section results in less wasted space than the square cross section, but in certain instances (e.g. when located at the end of a grouping of adjacent bottles within a traditional square pallet or rectangular cargo container) will have more wasted space than the square or rectangular shapes.

FIG. 4E also shows the amount of wasted space (a) that exists about the neck transition area of the bottles. FIG. 4E shows two bottles vertically stacked upon one another, to illustrate the amount of wasted space between adjacent vertically stacked bottles. FIG. 4E is representative of all bottles A, B, C and D. In FIG. 4E, line x represents the rear edge/corner of bottle C, while PA represents the front surface z of bottle C that is being viewed in FIG. 4E. FIG. 4E also shows front surface PA of bottles A, Band D.

FIGS. 5A through 5E show a space comparison analysis between various embodiments of water bottles (2) of the inventive concept, including bottle A2 with a square cross section (FIG. 5A), bottle B2 with a rectangular/rectilinear cross section (FIG. 5B), bottle C2 with a triangular cross section (FIG. 5C), and bottle D2 with a rounded/circular cross section (FIG. 5D). All bottles of FIG. 5 include neck forms of an embodiment of the inventive concept including a twist cap closure TH and a shortened neck area AC between body AD and cap-neck transition AB. FIG. 5E shows the amount of wasted space (a) that exists about the neck transition area of the bottles. FIG. 5E shows two bottles vertically stacked upon one another, to illustrate the amount of wasted space between adjacent vertically stacked bottles. As is shown in FIG. 5E, the bottles of these embodiments of the inventive concept include vertical interlock features. In FIG. 5E the cap TH is sized to fit within a recessed area with the bottom of a bottle stacked on top of the bottle. FIG. 5E is representative of all bottles A2, B2, C2 and D2. In FIG. 5E, line x represents the rear edge/corner of bottle C2, while Z represents the front surface z of bottle C that is being viewed in FIG. 5E. FIG. 5E also shows front surface PA of bottles A, Band Das surface Z. As is seen in FIG. 5, the amount of wasted space for vertical stacking of bottles is greatly reduced with the use of the shortened neck area AC of FIG. 5E.

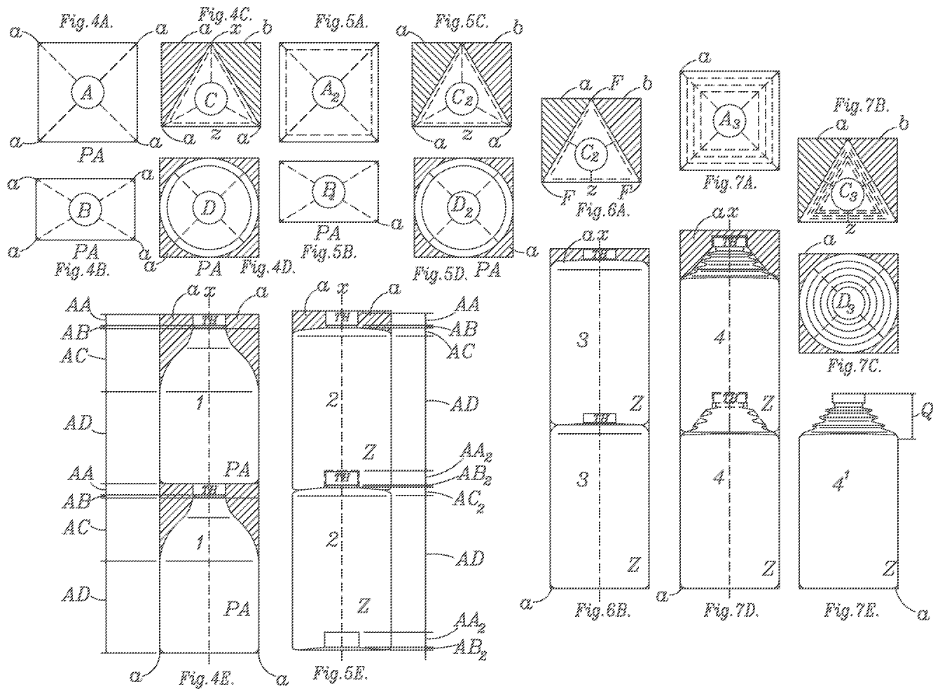

FIGS. 6A and 6B show a space comparison analysis for a triangular bottle (3) of the inventive concept including a flip portal closure HH and/or companion element (e.g. pop-top, stay tab, peel away opener, accordion/collapsible transition, etc.). FIG. 6B shows two bottles vertically stacked upon one another, to illustrate the amount of wasted space between adjacent vertically stacked bottles. As is shown in FIG. 6B, the bottles of these embodiments of the inventive concept include vertical interlock features. In FIG. 6B the cap HH is sized to fit within a recessed area with the bottom of a bottle stacked on top of the bottle. Although shown with respect to a triangular bottle, it will be appreciated that in other embodiments the closure feature of FIG. 6 will be utilized in connection with bottles of any shapes disclosed herein or hereinafter developed. In FIG. 6B, line x represents the rear edge/corner F of bottle C2, while Z represents the front surface z of bottle C2 that is being viewed in FIG. 6B. As is seen in FIG. 6, the amount of wasted space for vertical stacking of bottles is greatly reduced with the use of the shortened neck area AC of FIG. 6B.

In FIGS. 5 and 6, areas (a) represent end condition wasted space for all circumstances. Areas (b) in FIGS. 5 and 6 represent end condition wasted space only for circumstance in which adjacent bottles are not placed next to the adjacent surface of bottles C2. FIGS. 5 and 6 are intended to show wasted space conditions for situations in which a grouping of bottles is packaged together in a traditional square or rectilinear container. In such situations, the triangular shape of bottle C2 will result in one end condition in which wasted space (a) exists at one end of the container/package; however, wasted space (b) will not exist as the adjacent surface to (b) will be flush/flat to the edge of the container/package.

FIGS. 7A through 7E show a space comparison analysis between various embodiments of water bottles (4) of the inventive concept, including bottle A3 with a square cross section (FIG. 7A), bottle C2 with a triangular cross section (FIG. 7B), and bottle D3 with a circular cross section (FIG. 7C), for bottles including an accordion neck (Q) of the inventive concept. FIG. 7D shows two bottles vertically stacked upon one another, to illustrate the amount of wasted space between adjacent vertically stacked bottles. As is shown in FIG. 7D, the bottles of these embodiments of the inventive concept include vertical interlock features. In FIG. 7D the cap TH and accordion neck Q are sized to fit within a recessed area within the bottom of a bottle stacked on top of the bottle. In FIG. 7D, the accordion neck Q is in a compressed, or slightly compressed, position for vertical stacking. Although shown with respect to triangular, round and square bottles, it will be appreciated that in other embodiments the closure feature of FIG. 7 will be utilized in connection with bottles of any shapes disclosed herein or hereinafter developed. In FIG. 7D, line x represents the rear edge/corner of bottle C3, while Z represents the front surface z of bottle C3 that is being viewed in FIGS. 7D and 7E. As is seen in FIG. 7, the amount of wasted space for vertical stacking of bottles is greatly reduced with the use of the shortened neck area Q of FIG. 6E.

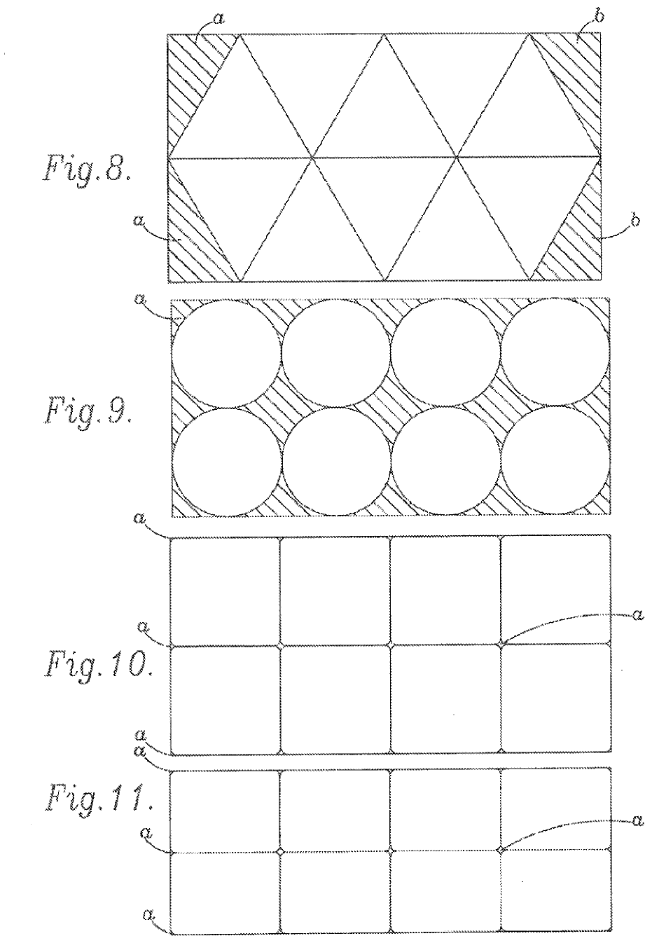

FIGS. 8 through 11 show an adjacency comparison analysis between various embodiments of water bottles (4) of the inventive concept, including square cross section (FIG. 10), triangular cross section (FIG. 8), circular cross section (FIG. 9) and rectangular cross section (FIG. 11). FIGS. 8 through 11 show the wasted space resulting from storing bottles of varying cross sections in adjacent relation to one another with a rectilinear container. As is shown in FIGS. 8 and 9, the triangular cross section has less wasted space than the circular cross section, but in the rectilinear contain will at least have wasted space (a) under all circumstances, and in many circumstances (depending upon the dimensions and shape of the container) will have wasted space (b). As is shown in FIGS. 10 and 11, the amount of wasted space within a rectilinear container is minimized with the square or rectangular cross section bottles.

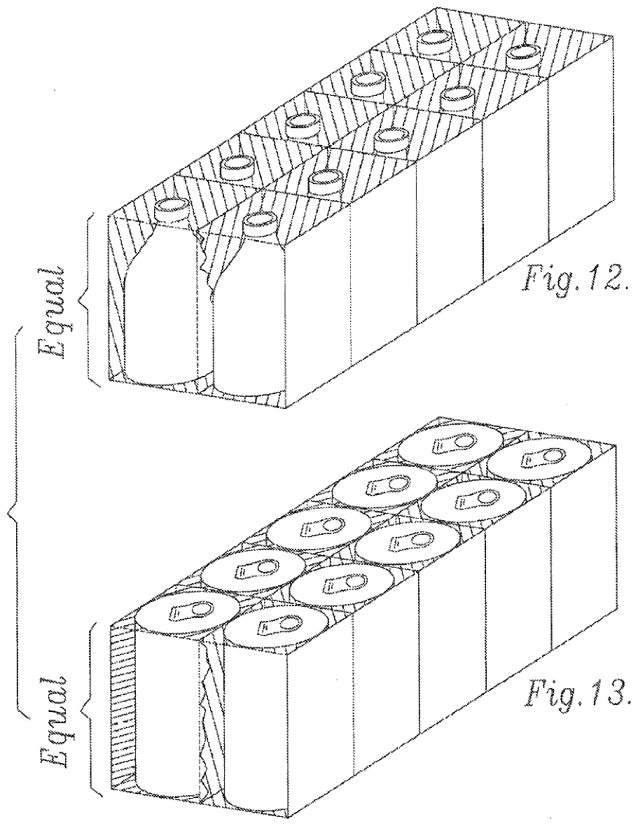

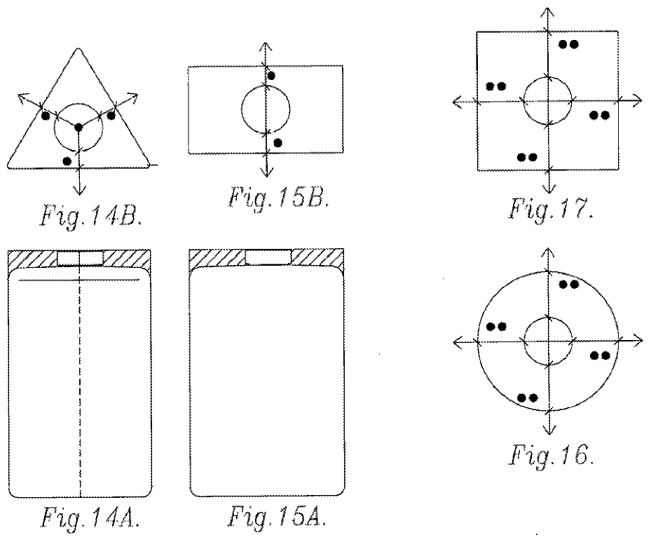

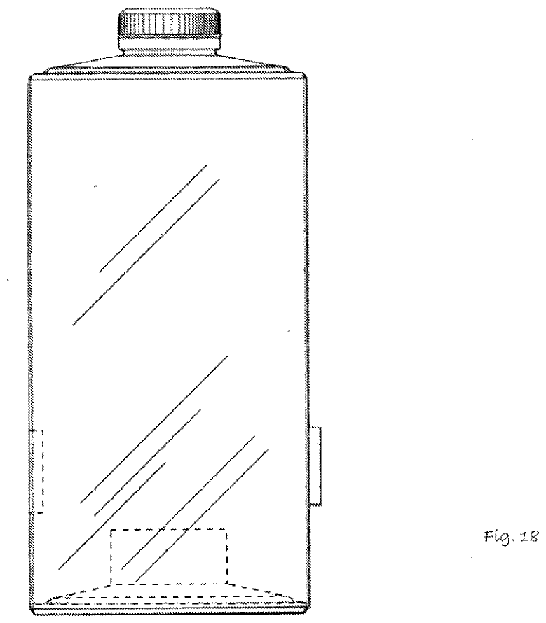

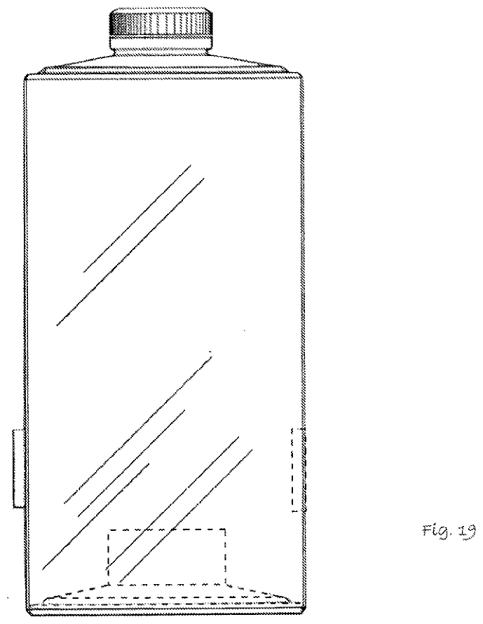

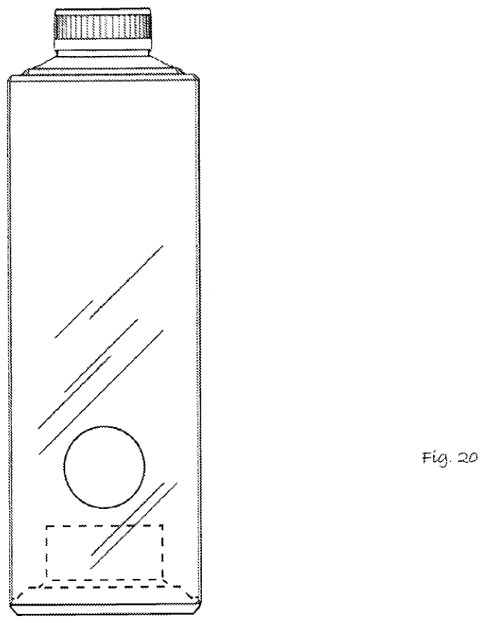

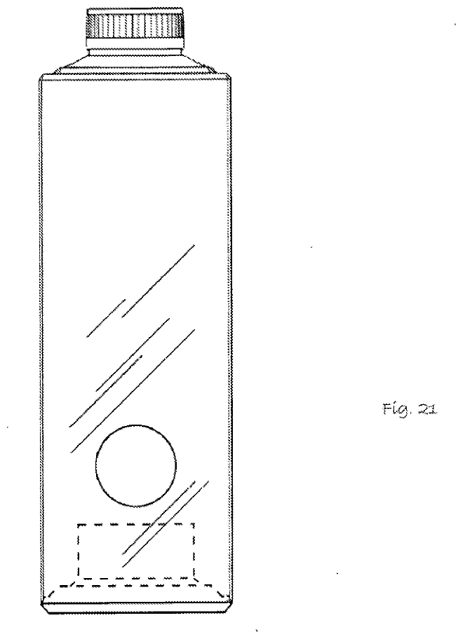

FIGS. 12 and 13 show an adjacency packaging comparison analysis in perspective view between various vessel embodiments of the prior art, including a typical disposable water bottle (FIG. 12), and a typical soda can (FIG. 13). As is shown in FIGS. 12 and 13, the typical long neck water bottle has more wasted space than the soda can about the neck area. Nevertheless, the soda can has significant wasted space surrounding adjacent surfaces.

FIGS. 14A through 16 show a preferred human interface comparison analysis between various vessel embodiments of the inventive concept, including triangular cross section (FIGS. 14A and 14B), rectangular/rectilinear cross section (FIGS. ISA and ISB), square cross section (FIG. 17), and circular cross section (FIG. 16). As is shown in FIGS. 14A and ISA, all the bottles shown in FIGS. 14A through 16 include a short neck transition between the bottle body and the conveyance portal. The portal openings for all bottle shapes in FIGS. 14A through 16 are of equal diameter. The arrows in FIGS. 14B, 15B, 16 and 17 illustrate the direction from the center in which a user's lips may be position for drinking from the portal. The single dots represent a short space interval between the portal and the edge of the vessel, while the double dots represent a long space interval between the portal and the edge of the vessel. As is shown, the triangular and rectilinear bottle shapes provide the shortest interval between the conveyance portal and the edge of the vessel. When using the shorter neck transition, this is beneficial as it provides for easier usage/drinking. The longer interval is difficult/inconvenient for the user. It is noted that in embodiments utilizing a long tapering neck transition the interval between the conveyance portal and the outer surface of the vessel body becomes less relevant for user convenience, as the tapering brings the vessel body further away from the user's mouth/lips during use.

FIG. 18 is a front elevation view of a rectilinear water bottle vessel embodiment of the instant inventive concept, including structural features for horizontal and vertical interlock with other bottles of identical structure. As is shown in FIG. 18, the left side of the bottle includes an internal recess (female horizontal interlock structure) for receiving a corresponding male horizontal interlock structure of an adjacent bottle. FIG. 18 shows on the right side of the bottle a protrusion that mates with the internal recess of an adjoining bottle. The protrusion is sized to have a slightly smaller external diameter than the internal diameter of the recess, so the protrusion is capable of mating within the recess of an adjoining bottle. FIG. 18 shows an internal recess at the bottom of the bottle (female vertical interlock structure) for receiving a corresponding top of an adjacent bottle on which the bottle is stacked. The recess is shaped to correspond to the top of the bottle, including the bottle cap TH over the portal. In one embodiment of a bottle of FIG. 18, the dimension of the bottle are as follows: the diameter of the twist off cap is approximately 1 inch; the cap height AA is approximately ½ inch; the cap neck transition height AB is approximately 1/16 inch; the top corner edges of the bottle are chamfered approximately 1/16 inch (this is also the neck area AC); the body height AD is approximately 5⅝ inches; the diameter of the horizontal interlock recess is approximately ⅞ inches, with a width extending into the bottle from the exterior surface of approximately ⅛ inches; the diameter of the horizontal interlock protrusion is approximately 13/16 inches, with a width protruding out of the exterior surface of the bottle by approximately 1/16 inches; the bottom edges of the horizontal interlocks are positioned approximately 1 inch from the bottom edge of the bottle body; the depth of the bottle form front to back is approximately 2 inches; the width form left to right is approximately 2⅞ inches; the recess at the bottom of the bottle includes an approximately 1/16 chamfer (but slightly larger than the top chamfer to accommodate mating with the top of corresponding bottles during stacking); the central portion of the recess includes a recess area to accommodate a cap TH of a mating bottle, with a depth slightly greater than approximately ½ inch and a width of approximately 1⅛ inches. This particular embodiment has been found to provide a grouping of bottles that horizontally stack together to fill the complete surface of a traditional pallet, while at the same time holding similar volume of water to traditional water bottles. Nevertheless, it will be appreciated that other embodiments include bottles of any varying dimensions.

FIG. 19 is a rear elevation view of the water bottle of FIG. 18.

FIG. 20 is a left side elevation view of the water bottle of FIG. 18, looking toward the female horizontal interlock structure.

FIG. 21 is a right side elevation view of the water bottle of FIG. 18, looking toward the male horizontal interlock structure that mates with the corresponding female interlock structure of other identical bottles.

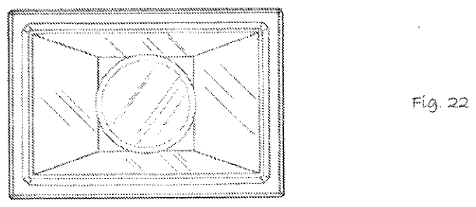

FIG. 22 is a bottom plan view of the water bottle of FIG. 18, looking toward the female vertical interlock structure.

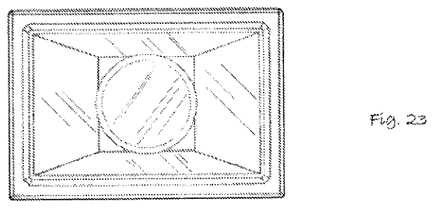

FIG. 23 is a top plan view of the water bottle of FIG. 18, looking toward the male vertical interlock structure (e.g. the top of the bottle and the cap TH) that mates with the corresponding female interlock structure of other identical bottles.

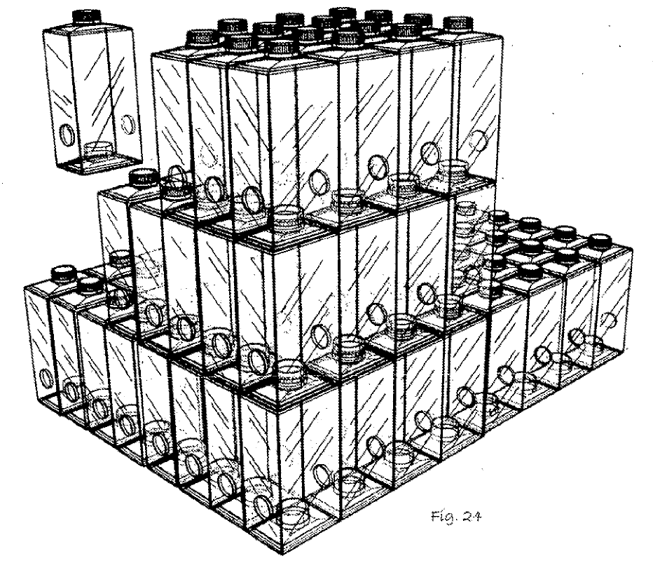

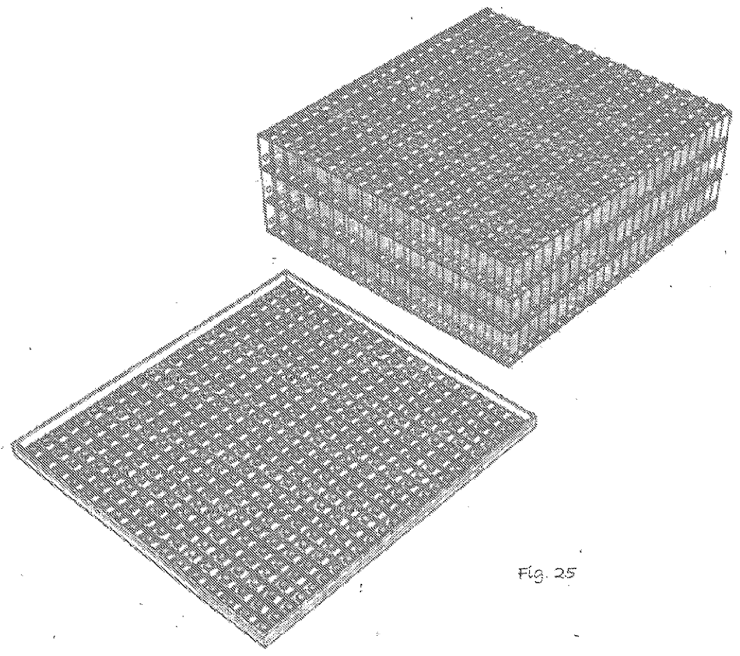

FIG. 24 is a frontal perspective view of a grouping of vessels of FIG. 18 being stacked together horizontally and vertically. As is shown, the bottles interlock both vertically and horizontally

FIG. 25 is an exploded frontal perspective view of a grouping of vessels of FIG. 18 stacked together and positioned upon a pallet tray of the inventive concept. The pallet tray of FIG. 25 includes a male vertical interlock structure that mates with the female vertical interlock structure of bottles places on the pallet. The pallet tray of the inventive concept, when used in combination with the bottles of FIG. 18 provides superior packaging integrity with minimal need for additional support. Shrink wrap or other straps or retention mechanisms can be wrapped around the top and bottom to compress vertically, without the need to wrap/support the sides (i.e. no need to support horizontally). In some embodiments, the one pallet tray is positioned at the bottom of a group of bottles, and another is positioned at the top of the bottles to provide additional structural integrity for the group. In some such embodiments, each pallet tray includes both male and female interlock features, so that a single pallet tray is capable of functioning as either a top or bottom tray, or both top and bottom at the same time.

Several exemplary embodiments of the inventive concept are further described in the number paragraphs below:

1. A method for optimizing space and/or resource allocation for, and utilization requirements of material, packaging, storage, transport, use, reuse and/or disposal and/or collectively a product of same, said method comprising the steps of:

determining materialization of the product to minimize wasted space and/or optimize product conveyance(s); and

designing the product with the materialization based upon said determining step.

In some such embodiments, the product is a vessel. In some embodiments, the vessel is a container. In some such embodiments, the container is a bottle for containing water or other liquid that is conveyed from the vessel. In some embodiments determining materialization is determining a grouping of vessels. For purposes of the inventive concept “Materialization” includes a determination as to elements, compounds, or substances for making the product (collectively “material characteristics”), groupings, placements, and/or adjacency relating to the product and other like or coordinated products.

Some embodiments of the inventive concept include method of reimagining the relationship of oxidation and respiration as it relates to the carbon cycle. In this manner, the inventive concept accounts for the entire life cycle of a product, from the original materials used in the product to the final disposal of the product. The inventive concept utilizes concepts similar and/or consistent to Michaelis-Menten kinetics and/or superseding principles. In that regard, embodiments of the methods of the inventive concept are intended to design/develop products that go full circle, e.g. from seed to bottle and with the purpose of an end material(s) (post use of the product—e.g. upon disposal of an empty water bottle) back to at least help the seed (either through oxidation or respiration), and start the cycle over again for new products. In some embodiments, the inventive concept lifecycle results in a disposal of the product that goes back into the original lifecycle (e.g. by breaking product down to components that help replenish the original resource used). In other embodiments, the inventive concept lifecycle results in a reuse of the product for other purposes (e.g. a water bottle is filled with dirt and used as a construction component).

For purposes of the instant invention, the term “renewable” is reimagined and redefined such that oil or other resources are considered “renewable” products. For example, oil is “renewable” over a long enough period of time. In some embodiments, the inventive concept utilizes oil or other resources, taking into account the life cycle and renewability of oil as part of the optimization process. The inventive concept differs from “renewable” resources of the prior art in that the entire life cycle is considered as part of the process. For example, in prior art methods plastic may be made from corn byproducts, and corn is considered a “renewable” resource because it can be grown and regrown. Notwithstanding, method of making bottle form corn based plastic fail to take into account the other resources that may be plundered or overused in the process, including resources for growing/fertilize the corn, harvesting, etc., and resources for hauling manufactured product, storage, and disposal of the product at the end of its use. The inventive concept considers one or more (in some embodiments, more than one, in some embodiments, all or close to all) aspects in the life cycle of the product from design/structure, use of materials, manufacture, transport, storage, use, disposal post use, interrelation of multiple products together with each other, etc., to optimize the life cycle and use of resources. The inventive concept in some embodiment considered the elements of a product itself—e.g. the way the carbons line up (carbon chain)—reimagining making and breaking carbon chains in a carbon based universe. Embodiments of the inventive concept provide a method of indexing and conserving and/or accounting for the use of carbon and/or other resources. Some embodiments of the inventive concept index all components of the product or product design, manufacturing, use, disposal, process, such as substrates (or carbon), catalysts/agents, by-products, and energy(s), in terms of total energy and entropy requirements (through the entire lifecycle of the product). In some embodiments, components of the product of the inventive concept are designed based on product lifecycle to perform more than one function (e.g. conveyance portal also functions as interlock for mating vessels).

For purposes of the inventive concept the term “conveyance” broadly includes the materials of which the product and/or its packaging are made, as well as the purpose, delivery, transport, storage, use, reuse and/or disposal of the product itself. For example, in some embodiments in which the product is a water bottle, conveyance includes the adjacency of two bottles group together and how they related to one another. In some water bottle embodiments, conveyance includes how the contents (e.g. the water within the bottle) are conveyed from the interior space of the bottle to the user. In some water bottle embodiments, conveyance includes how the grouping (e.g. pallet) of bottles are conveyed from the manufacturer to a retail point of sale location. In some embodiments, conveyance includes how the bottle is disposed of after the contents have been conveyed from the bottle.

Products of the instant inventive concept are Compangineered to be formed, and/or deformed, by organic intention, by intrinsic particles, inert or active or activatable, internal or external elements, microbes, organisms, compounds, materials, methods and/or other means (defined herein as “Constituency”).

2. The method as set forth in embodiment 1 wherein the product comprises a group of vessels, wherein said determining step comprises determining groupings of vessels to minimize wasted space and/or optimize vessel conveyance(s); and wherein said designing step comprises designing individual vessels within the group based upon said determining step.

3. The method as set forth in embodiment 2 wherein said determining step comprises the step of optimizing vessel conveyance(s), and wherein said vessel conveyance(s) comprises a vessel shape.

4. The method as set forth in embodiment 2 wherein said determining step comprises the step of optimizing vessel conveyance(s), and wherein said vessel conveyance(s) comprises a vessel purpose.

5. The method as set forth in embodiment 4, wherein said vessel purpose comprises the delivery of a conveyable substance.

In some embodiments, the conveyable substance is potable water.

6. The method set forth in embodiment 2 wherein said determining step comprises the step of optimizing vessel conveyance(s), and wherein said vessel conveyance(s) comprises a vessel life cycle and/or shelf life for a vessel

7. The method as set forth in embodiment 6 wherein in said optimizing step recycling, repurposing and/or disposal of the vessel is determined.

8. The method as set forth in embodiment 7 wherein in said optimizing step a preferred material for optimizing recycling, repurposing and/or disposal of said vessel is determined.

9. The method as set forth in embodiment 8 wherein in said optimizing step a preferred trigger for initiating said recycling, repurposing and/or disposal of said vessel is determined in coordination with said vessel material.

10. The method as set forth in embodiment 9 wherein said trigger is an agent that decomposes said vessel material.

For purposes of the inventive concept the term “agent” includes element, enzyme, compound, microbe, microbial, microplasm, energy, bacteria, accelerant, retardant, activator, catalyst, organism, etc. or anything that ingests or digests the product (or part thereof), or reproduces or replicates the product (or part thereof), or otherwise facilitates anabolic and/or catabolic existence of the product (or part thereof) and/or internal or external reductive processes relating to the product.

11. The method as set forth in embodiment 2 wherein said determining step comprises the step of optimizing vessel conveyance(s), and wherein said vessel conveyance(s) comprises a vessel contents.

12. The method as set forth in embodiment 11 wherein in said optimizing step vessel contents are enhanced, modified, contributed to and or amplified by said vessel.

13. The method as set forth in embodiment 12 wherein said optimizing of vessel contents is performed on demand.

14. The method as set forth in embodiment 12 wherein said optimizing of vessel contents is performed in a progressive manner.

15. The method as set forth in embodiment 12 wherein said optimizing of vessel contents is performed in a controlled and/or triggered manner.

16. The method as set forth in embodiment 2 wherein contents of at least one vessel contribute to the determining step and wherein said determining step includes determining of form, function, and/or purpose of vessels, groupings of vessels, vessel packaging, and/or packaging systems.

17. The method as set forth in embodiment 2 wherein said determining step comprises defining preferred adjacency(s) of adjacent vessels within the group of vessels.

For purposes of the inventive concept “adjacency” means that products are Compangineered to be compatible, conforming, or competing with other products. Adjacency includes category, class or group strategies. For example, adjacency of a water bottle in some embodiments includes how the individual bottle stacks horizontally and/or vertically with other similar bottles into a case or pallet of bottle. In some embodiments, adjacency includes how packages of multiple bottles are grouped together into a pallet, container, retail shelf, or other area.

18. The method as set forth in embodiment 17 wherein said preferred adjacency(s) comprises one or more symbiotic surface(s) of adjoining vessels' walls.

19. The method as set forth in embodiment 18 wherein said one or more symbiotic surface(s) includes inter-relating elements of reciprocating form(s) and/or function(s).

20. The method as set forth in embodiment 19 wherein said inter-relating elements comprise a male element on the surface of a first vessel and a female element on the surface of a second vessel for receiving said male element of the first vessel.

21. The method as set forth in embodiment 19 wherein said inter-relating elements comprise a strategically placed planar surface, portion of a planar surface, or feature of a planar surface

22. The method as set forth in embodiment 21 comprising a feature of a planar surface, wherein said feature is a vessel base, portion of a vessel base, sidewall, and/or top of a vessel.

23. The method as set forth in embodiment 17 wherein said preferred adjacency(s) are an accommodation of or for an otherwise usual and customary functional element of the vessel.

24. The method as set forth in embodiment 23 wherein said usual and customary functional element of the vessel is a vessel cap or a portion of a vessel portal covering.

For purposes of the inventive concept, portal covering includes a cap, lid, or other closure for the vessel portal/opening.

25. The method as set forth in embodiment 17 wherein said preferred adjacency(s) function as an element to optimize an individual vessel and/or contributes to optimization of a grouping of vessels.

26. The method as set forth in embodiment 25 wherein said preferred adjacency(s) comprising adjacent sidewalls, or portions of sidewalls of adjacent vessels.

27. The method as set forth in embodiment 17 where said determining step further comprises determining concomitantly adjacencies of one or more vessels for purposes of minimizing space between vessels and/or containers of multiple vessels, minimizing and/or optimizing packaging, and/or minimizing and/or optimizing packaging systems.

28. The method as set forth in embodiment 27 wherein groups of vessels, or containers of multiple vessels are positioned horizontal to one another and/or vertical to one another.

29. The method as set forth in embodiment 17 wherein said preferred adjacency(s) comprises one or more surface features on a surface of adjacency for enhancing the vessel, packaging of the vessel, storage of the vessel, and/or transport of the vessel.

30. The method as set forth in embodiment 2 wherein said determining step comprises the step of determining space requirements in terms of volume, mass and/or entropy of internal containment(s) and/or external adjacency(s) of one or more of said individual vessels.

31. The method as set forth in embodiment 30 wherein internal containment(s) comprise the contents of the vessels.

32. The method as set forth in embodiment 30 wherein internal containment(s) comprise one or more surface feature(s) on an internal surface of one or more of said individual vessels.

33. The method as set forth in embodiment 23 wherein external adjacency(s) comprise one or more surface feature(s) on an external surface of one or more of said individual vessels.

34. The method as set forth in embodiment 2 wherein said determining step comprises the step of advantaging concomitantly form and function of individual vessels through coordinated adjacency(s) of one or more vessels and/or containers of vessels.

35. The method as set forth in embodiment 2 wherein said determining step comprises the step of advantaging concomitantly form and function of individual vessels through coordinated adjacency(s) of one or more planar surface, portion of a planar surface, or functional element of a planar surface, of one or more vessels.

36. The method as set forth in embodiment 2 wherein said determining step comprises the step of designing and/or modeling packaging systems, groupings of packaging for vessels and individual vessels with preferred adjacency(s) and/or symbiotic interrelationships, for purposes of a collective gestalt of form, function and materiality of and for more than one vessel.

37. The method as set forth in embodiment 2 wherein the vessel(s) are individually sized single-use potable water bottles.

38. The method as set forth in embodiment 1 wherein the vessel(s) are of any size and purpose. In some such embodiments, the vessel include a box, car, bike, etc.

39. The method as set forth in embodiment 2 further comprising the step of determining a material for manufacturing the vessels based upon the contents, intended purposes of contents, and/or vessel purpose.

40. The method as set forth in embodiment 1 wherein the product comprises a group of vessels, wherein said determining step comprises determining material characteristics to minimize wasted space and/or optimize vessel conveyance(s); and wherein said designing step comprises designing individual vessels within the group based upon said determining step.

41. A method for the simultaneous and/or coordinated sequential use of conceptual and computerized modeling methods for space and material allocation, award and assignment in pursuit of preferred packaging systems, packaging, and individual vessels of and/or for packaging, the method comprising the steps of: assessing, grading and employing viscoelastic properties of materials of packaging systems, packaging and vessels of and for containment; identifying, allocating and coordinating available space for purposing all adjacent and/or coincident space and concomitantly optimizing vessel form and function within said space.

42. The method as set forth in embodiment 40 further comprising the steps of employing concomitant static and dynamic analysis of materials, material characteristics and material capabilities to optimize material and space allocation and performance of packaging systems, packaging and/or vessels of said packaging.

43. The method as set forth in embodiment 40 further comprising the steps of purposing concomitantly local, regional and/or system-wide material consistency(s), thickness(s), cross sectional profile, shape(s), form(s) and function(s) of one or more vessels in context of space allocation via computer modeling, and/or artificial intelligence.

44. The method as set forth in embodiment 43 wherein said purposing step utilizes an adaptive learning mechanism.

45. The method as set forth in embodiment 40 further comprising the steps of promulgating advantages of adjacency(s) of more than one vessel via modeling optimization.

46. The method as set forth in embodiment 45 wherein said modeling optimization comprises, computer and/or CAD/CAM modeling.

47. The method as set forth in embodiment 40 further comprising the steps of perpetuating advantages of material and space allocation from individual vessel design origination through all matters of adjacency(s) of more than one vessel and associated packaging and/or packaging systems.

48. A method of companion sizing, orienting and purposing vessels, vessel walls, vessel surfaces and features to cooperatively and collectively conserve resources of space of vessel making, maintenance, storage and transport and that of vessel contents, the method comprising the steps of: assessing preferred ergonomics of vessel form and function associated with end use in context of vessel passive and/or active content containment, storage, transport, and/or lifecycle; integrating active ergonomics of an individual vessel with collective adjacencies of more than one other vessel to advantage all vessels within the space; and increasing opportunities of form, surface and/or element adjacencies of like vessels to reduce wasted internal and external vessel space in common.

49. The method as set forth in embodiment 48 further comprising the steps of advantaging conservancy of time, space, energy and/or material for the lifecycle of vessels through original conceptionalization, modeling and making of vessels.

50. The method as set forth in embodiment 48 further comprising the steps allowing for planned formation, deformation and/or reformation lifecycle of one or more vessels as part of original design determinations.

51. A method of designing a vessel, the method comprising the steps of: allowing flow-able contents to assume the transient shape and form of a vessel and/or concomitantly lend structural integrity, shape, form and intended metrics to the vessel.

52. A method for designing a vessel and grouping of like vessels comprising the steps of achieving and maintaining vessel intended shape, form, mass and usefulness throughout a programmed period of containment under external loading of one or more grouped vessels; and allowing vessel shape, form, mass and usefulness to discontinue following said programmed period.

For example, in some embodiments the contents of the vessel shape physically help to form the shape of the vessel (e.g. water within a flexible vessel adds some rigidity to the vessel). In some embodiments the contents of the vessel provide physical characteristics to the vessel, such as rigidity. In some embodiments, the contents of the vessel provide elemental characteristics to the vessel (e.g. the material from which the vessel is made is designed to break down its chemical bonds wen the contents are no longer present).

53. The method as set forth in embodiment 52 wherein said vessels include a programmed material lifecycle beyond containment.

54. The as set forth in embodiment 52 or embodiment 2 further comprising the steps of purposing vessels in groupings of one or more vessel to maintain 3-dimensional integrity under loading in usual and customary axes, and or off axes (e.g if the vessel is titled, off center or not level, it still has integrity), of orientation for storage, use and/or transport. Some embodiments apply to the structure of the vessel itself and/or the contents, while others apply to the structure of the vessel plus the contents.

55. A method of designing a vessel that includes one or more axes of nesting of more than one vessel for purposes of maintenance and/or enhancement of the continuity of structural integrity and/or intended spatial orientation of any individual vessel and/or mission capability of groupings of like vessels, the method comprising the steps of: considering symbiotic adjacencies of one or more planar surface, surface elements and/or features of adjacent vessels to achieve and maintain nesting; designing adjacencies to provide nesting of more than one vessel and/or groupings of vessels, packaging, and/or packaging systems.

56. The method as set forth in embodiment 55 further comprising the steps of employing adjacency nestings to reduce the need for external, exophytic and/or supplemental means of maintaining continuity of intended adjacencies of more than one vessel and contents within vessels.

57. The method as set forth in embodiment 55 further comprising the steps of resisting and/or accommodating forces (including on or off axes) of random, intermittent, constant and/or consistent spatial disruption of groupings of like vessels.

58. The method as set forth in embodiment 55 further comprising the steps of reducing the lifecycle energy requirements of making, maintaining, and/or transporting individual vessels through a gestalt of group functioning nesting adjacencies of more than one capabilities of vessel.

59. The method as set forth in embodiment 55 further comprising the steps of reducing the material, energy and massing requirements of an individual vessel through planned partitioning of space and time by preferred adjacencies and associated nestings.

60. The method as set forth in embodiment 55 wherein vessels are made from and/or relative to one or more, and/or a combination of materials from the group consisting of polymeric, composite, rigid, semi-rigid, viscoelastic materials, multi-phasic, multi-layered material, and energy force field(s) acting as a material. Embodiments of the inventive concept include products made from any known or invented materials, including those set forth above, now known or developed in the future, as well as layers, composites, aggregate, aggregate associations of materials.

61. The method as set forth in embodiment 55 wherein like vessels are made of the same material(s).

62. The method as set forth in embodiment 55 wherein like vessels are made of differing material(s).

63. The method as set forth in embodiment 55 wherein the vessel is a single-use or reusable water bottle.

64. The method as set forth in embodiment 55 wherein the vessel is made from one or more agent, ions, elements, enzyme, microbial, microplasm, energy particles, precipitates, compounds, peptides or polypeptides, plastics, polymers, and/or composites of natural, recombinant and/or synthetic origin.

65. A method of initiating the making of vessels, perpetuating and/or terminating a lifecycle of vessels, groupings of vessels, packaging, and/or packaging systems that originates from historic and/or progressively/adaptively updated and learned data points, analyses, and of compendiums of relevant information, data points and/or references, the method comprising the steps of: storing, analyzing, applying and/or devolving metrics and data points regarding vessels, groups of vessels, packaging, and/or packaging systems for vessels; storing, analyzing, applying and/or devolving data points of preferred and disparate adjacencies and groupings of more than one vessel and/or nesting, materiality lifecycle, groupings of vessels and/or packaging, or packaging systems for vessels and/or groups of vessels; storing, analyzing, applying and/or devolving packaging dynamics, interactions of and between vessels, groupings of vessels and packaging systems in the making, storage, transport and/or use of vessels and contents of vessels; storing, analyzing, applying and/or devolving requirements of energy(s), massing(s), spacing(s) for individual vessels and grouping of vessels, packaging, and/or packaging systems; and storing, analyzing, applying and/or devolving realized contributions of adjacency(s), nesting(s), materiality(s), containment methods and means, principles and practices of conception, realization, manufacture, utility, recovery and/or recycling necessary and desirable for optimizing designed vessels, groupings of vessels, packaging, and/or packaging systems, and vessel lifecycles.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the inventions is by way of example, and the scope of the inventions is not limited to the exact details shown or described

Although the foregoing detailed description of the present invention has been described by reference to an exemplary embodiment, and the best mode contemplated for carrying out the present invention has been shown and described, it will be understood that certain changes, modification or variations may be made in embodying the above invention, and in the construction thereof, other than those specifically set forth herein, may be achieved by those skilled in the art without departing from the spirit and scope of the invention, and that such changes, modification or variations are to be considered as being within the overall scope of the present invention. Therefore, it is contemplated to cover the present invention and any and all changes, modifications, variations, or equivalents that fall within the true spirit and scope of the underlying principles disclosed and claimed herein. Consequently, the scope of the present invention is intended to be limited only by the attached claims, all matter contained in the above description and shown in the accompanying drawings shall be interpreted as illustrative and not in a limiting sense.

Having now described the features, discoveries and principles of the invention, the manner in which the invention is constructed and used, the characteristics of the construction, and advantageous, new and useful results obtained; the new and useful structures, devices, elements, arrangements, parts and combinations, are set forth in the appended claims

It is also to be understood that the following claims are intended to cover all of the generic and specific features of the invention herein described, and all statements of the scope of the invention which, as a matter of language, might be said to fall therebetween.

What is claimed is:

1. A vessel comprising:
a body having a first side, second side, third side, fourth side, a top, and a bottom;
each side is substantially rectilinear with substantially equal dimensions,
the first side is connected to the second and fourth sides,
the third side is connected to the second and fourth sides, opposite the first side such that the four sides form a three-dimensional rectilinear shape,
the bottom is connected to each of the four sides, and the top is connected to each of the four sides opposite the bottom such that the four sides, top, and bottom form a fluid impermeable cavity;
the top comprises
a protrusion that extends away from each of the four sides; and
and access hole in the protrusion that allows matter to enter and exit the cavity; and
a cap that covers and seals the access hole;
the bottom comprises a bottom indentation, wherein the shape of the bottom indentation comprises the negative image of the shape of the top such that an object having the shape of the top nests within the bottom indentation;
the first side further comprises a side protrusion extending from an exterior surface plane of the first side and extending either
a) perpendicular to the exterior surface plane; or
b) at an acute inward angle to the exterior surface plane such that the protrusion does not extend over the any portion of the first side;
wherein the side protrusion exhibits a three dimensional shape; and
the third side further comprises a side recess extending inward, into the cavity, wherein the wall recess exhibits a shape that comprises the negative image of the shape of the side protrusion such that an object having the shape of the side protrusion nests within the wall recess.

2. A vessel as in claim 1 wherein, the wall recess is formed in the third side in a location that is directly opposite and aligned with the location of the side protrusion formed in the first side.

3. A vessel as in claim 2 wherein the wall recess and the side protrusion are located closer to the bottom than to the top.

4. A vessel as in claim 3 wherein the wall recess is located in the bottom third of the third side and the side protrusion is located in the bottom third of the first side.

5. A vessel as in claim 1 wherein the second side and the fourth side are each substantially smooth and do not contain any protrusions or indentations.

6. A vessel as in claim 1 wherein the side protrusion and wall recess are each circular in cross-section.

7. A vessel as in claim 6 wherein the side protrusion has a diameter of approximately 13/16 of an inch and the side protrusion protrudes from the side wall no more than approximately 1/16 of an inch; and
wherein the side recess has a diameter of approximately ⅞ of an inch and the side recess extends into the cavity approximately ⅛ of an inch.

8. A vessel as in claim 1 wherein the top protrusion includes a portion that is pyramidal.

9. A vessel as in claim 1 wherein the side protrusion and wall recess are sized such that an object having identical dimensions to the side protrusion fits within the wall recess but does not frictionally engage the wall recess.

10. A vessel as in claim 1 wherein the top and bottom indentation are sized such that an object having identical dimensions to the top fits within the bottom indentation but does not frictionally engage the bottom indentation.

11. A vessel as in claim 1 wherein the volume of the cavity is substantially equal to the volume of a three-dimensional space defined by a rectangular prism having
a first planar side with a perimeter equal to a perimeter of the first side;
a second planar side with a perimeter equal to a perimeter of the second side;
a third planar side with a perimeter equal to a perimeter of the third side; and
a fourth planar side with a perimeter equal to a perimeter of the fourth side.

12. A vessel as in claim 1 wherein the side protrusion comprises a base, an upper portion, a protrusion wall and a mating surface wherein
a) The upper portion is the area of the protrusion where the protrusion wall transitions to the mating surface, which area defines an upper circumference;
b) The base is the area of the protrusion where the protrusion wall transitions to the first side, which area defines a base circumference;
c) the protrusion wall separates the mating surface from the first side and joins the mating surface to the first side;
wherein at no point along the protrusion wall is a cross-sectional circumference of the protrusion wall greater than the base circumference.

13. An arrangement of vessels comprising:
at least a first vessel, a second vessel, a third vessel and a fourth vessel, wherein each of the a first vessel, a second vessel, a third vessel and a fourth vessel have substantially the same dimensions and each comprises:
a body having a first side, second side, third side, fourth side, a top, and a bottom;
each side is substantially rectilinear with substantially equal dimensions,
the first side is connected to the second and fourth sides,
the third side is connected to the second and fourth sides, opposite the first side such that the four sides form a three-dimensional rectilinear shape,
the bottom is connected to each of the four sides, and the top is connected to each of the four sides opposite the bottom such that the four sides, top, and bottom form a fluid impermeable cavity;
the top comprises
a protrusion that extends away from each of the four sides; and
and access hole in the protrusion that allows matter to enter and exit the cavity; and
a cap that covers and seals the access hole;
the bottom comprises a bottom indentation, wherein the shape of the bottom indentation comprises the negative image of the shape of the top such that an object having the shape of the top nests within the bottom indentation;
the first side further comprises a side protrusion extending from an exterior surface plane of the first side and extending either
a) perpendicular to the exterior surface plane; or
b) at an acute inward angle to the exterior surface plane such that the protrusion does not extend over the any portion of the first side;
wherein the side protrusion exhibits a three dimensional shape; and
the third side further comprises a side recess extending inward, into the cavity, wherein the wall recess exhibits a shape that comprises the negative image of the shape of the side protrusion such that an object having the shape of the side protrusion nests within the wall recess;
wherein the vessels are arranged such that
a) the side protrusion of the first vessel is nested within the side recess of the second vessel;
b) the top of the third vessel is nested within bottom indentation of the first vessel;
c) the side protrusion of the third vessel is nested within the side recess of the fourth vessel; and
d) the top of the fourth vessel is nested within the bottom indentation of the second vessel.

14. A arrangement of vessels as in claim 13 wherein none of the first vessel, second vessel, third vessel, or fourth vessel is frictionally engaged with any one of the first vessel, second vessel, third vessel, or fourth vessel.

15. An arrangement of vessels as in claim 13 wherein, without altering the orientation of any of the second vessel, third vessel, or fourth vessel, and without deforming the structure of any of the vessels, the first vessel cannot be removed from the arrangement without tilting the top of the first vessel away from the side recess of the second vessel.

16. An arrangement of vessels as in claim 13 wherein no side protrusion of any vessel frictionally engages any side recess of any of the other vessels.

17. An arrangement of vessels and in claim 16 wherein no top of any vessel frictionally engages any bottom indentation of any of the other vessels.

18. An arrangement of vessels as in claim 13 wherein no side protrusion of any vessel mechanically connects to any side recess of any of the other vessels.

19. An arrangement of vessels and in claim 18 wherein no top of any vessel mechanically connects to any bottom indentation of any of the other vessels.
